(19) United States
(12) Patent Application Publication
(10) Pub. No.: US 2005/0289131 A1
(43) Pub. Date: Dec. 29, 2005

(54) Inferred endorsement system and method

(76) Inventors: William M. Aenlle, Altadena, CA (US); Frank F. Balle, Alhambra, CA (US)

Correspondence Address: CHRISTIE, PARKER & HALE, LLP, PO BOX 7068, PASADENA, CA, 91109-7068, US

(21) Appl. No.: 11/166,413

(22) Filed: Jun. 24, 2005

Related U.S. Application Data
(60) Provisional application No. 60/583,143, filed on Jun. 25, 2004.

(51) Int. Cl. G06F 17/30

(52) U.S. Cl. 707/3

(57) ABSTRACT

An inferred endorsement (IE) system and method allows members of a micro-community (MC) to share information on experiences with purchased products or services with other members of the MC, via a webpage dedicated to the MC. Once a member of the MC, the member's purchases at participating e-commerce sites may be exposed to the MC by posting it on the webpage. The posting information may be maintained in private so that only the members of the MC may view and comment. The MC creator may populate the MC by inviting potential members to join the MC. An invitee joins the MC upon registering with an IE server hosting the MC webpage. Once a member, the invitee may access the MC webpage and exchange product and service experience information with other MC members.

### CROSS-REFERENCE TO RELATED APPLICATION

This application claims the benefit of U.S. Provisional Application Ser. No. 60/583,143, filed on Jun. 25, 2004, the content of which is incorporated herein by reference.

### BACKGROUND OF THE INVENTION

Among the various marketing tools, word-of-mouth is often one of the more effective. People share their product experiences, whether good or bad, in person at social gatherings, via phone, or e-mail. A drawback to word-of-mouth exchanges, however, is that it requires some kind of direct communication.

There are many e-commerce communities that allow people to express their views and/or ratings on, particular products without requiring direct communication. Such views and ratings, however, are often from strangers, and thus, not as effective as they would be in their persuasive power if such views and ratings would have come from trusted sources such as friends and family.

Accordingly, what is desired is a system and method that provides an online equivalent of word-of-mouth that shares product endorsement information directly with friends and family in a safe, efficient, and un-intrusive manner.

### SUMMARY OF THE INVENTION

The present invention is directed to a system and method for generating an online community. A first end user device generates a request to invite an invitee to join a particular online community. A server coupled to the first end user device receives the request and in response, transmits the electronic invitation to the invitee. A second end user device coupled to the server receives the electronic invitation and generates an electronic acceptance indication in response. The server adds the invitee to the particular online community and provides a website for the particular online community for allowing exchange of product and service experience information among the online community members.

According to one embodiment of the invention, the server automatically posts on the website information on purchases made by the online community members. The information may be product or service rating information, and may be kept private for viewing by only the members of the posting person's community.

According to another embodiment of the invention, the server provides a dedicated electronic bulletin board for a particular purchased product or service. Discussions on the bulletin board are then centered around the particular product or service.

According to a further embodiment of the invention, the invitee is restricted from further inviting a second invitee to the online community. In this manner, an MC creator may control the degrees of separation between the creator and each member of the MC.

According to another embodiment, the present invention is directed to an inferred endorsement server and method. The server includes a processor and a memory operably coupled to the processor that has program instructions stored therein, where the processor is operable to execute the program instructions. The program instructions include detecting purchase of an item at a merchant site; posting information about the purchased item at a second site; limiting access to the second site to members of a micro-community; and electronically charging the merchant in response to the posting of the information.

According to one embodiment, the instructions further include generating a dedicated electronic bulletin board for the purchased item on the second site.

It should be appreciated, therefore, that the claimed system and method provides a safe environment where members of a micro-community may exchange product experiences in an un-intrusive manner. Furthermore, user purchases from diverse e-commerce sites may be aggregated at a central location. Such exposure of consumer purchase information to the micro-community for viewing and discussion act as an endorsement of the purchase itself, and leads to new business from the community members. Because such an inferred endorsement is valuable to retailers, advertising fees are charged for exposing the purchase information to the micro-community.

These and other features, aspects and advantages of the present invention will be more fully understood when considered with respect to the following detailed description, appended claims, and accompanying drawings. Of course, the actual scope of the invention is defined by the appended claims.

### BRIEF DESCRIPTION OF THE DRAWINGS

In the drawings, which constitute part of this specification, exemplary embodiments demonstrating various features of the invention are set forth as follows:

FIG. 1 is a schematic block diagram of an inferred endorsements (IE) system according to one embodiment of the invention;

FIG. 2 is an architecture block diagram of an IE server, an end user device, and retailer and affiliate devices according to one embodiment of the invention;

FIG. 3 is an illustration of an exemplary home page displayed to a user upon access to his micro-community according to one embodiment of the invention;

FIG. 4 is a screen shot of an MC listings page displaying listings of products purchased by one or more members of a micro-community according to one embodiment of the invention;

FIG. 5 is a screen shot of an add listings page for adding a purchase listing to the MC listings page of FIG. 4 according to one embodiment of the invention;

FIG. 6 is a screen shot of a purchase archive page according to one embodiment of the invention;

FIG. 7 is a screen shot of a page displaying various private forums according to one embodiment of the invention;

FIG. 8 is a screen shot of a page displaying various general forums according to one embodiment of the invention;

FIG. 9 is a screen shot of a page displaying information on members of a micro-community according to one embodiment of the invention;

FIG. 10 is a flow diagram of a process implemented by an IE server for populating a micro-community according to one embodiment of the invention; and

FIGS. 11A-11B are screen shots of pages displayed to a user by a retailer device upon completion of a purchase from the retailer according to one embodiment of the invention.

### DETAILED DESCRIPTION OF THE INVENTION

In general terms, the present invention is directed to an inferred endorsement system and method which allows members of a micro-community (MC) to share product or service purchase information, including experiences with purchased products, product reviews, and the like, with other members of the MC. A user may set up his or her own MC, or be invited to join an existing MC. According to one embodiment, the MC is composed of a circle of friends and family, but may also extend to include other people, such as, for example, friends-of-friends, neighbors, other social acquaintances, and the like.

Once a member, the user's purchases at participating e-commerce sites may be automatically exposed to his or her MC upon approval from the user. Because the mere purchase of the product acts as an endorsement of the product and the retailer from whom the product was purchased, the exposing of such purchase to the MC members serves to promote the retailer and the product. Accordingly, the retailer benefiting from such promotion pays a promotion fee to the posting entity.

The MC provides different forums where the user may then share his or her experience with the purchased product or service (collectively referred to as a product). Because the MC is composed of a circle of friends and family, a reader of comments for a particular product benefits from knowing who the writer is. Thus, there is an added dimension of trust that accompany the reviews and comments of different products.

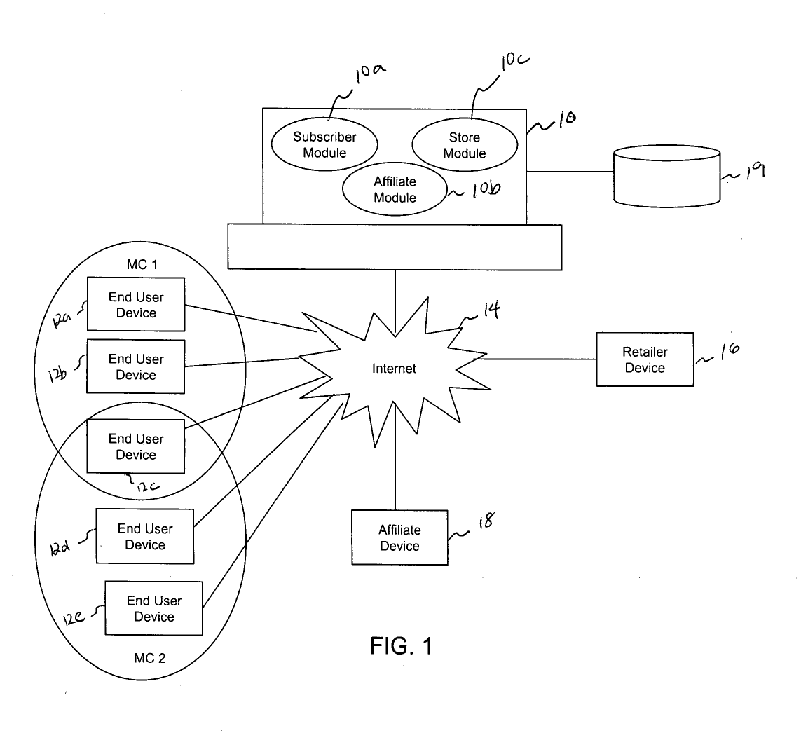

FIG. 1 is a schematic block diagram of an inferred endorsements (IE) system according to one embodiment of the invention. The system includes an IE server 10 coupled to various end user devices 12a-12e (collectively referred to as 12) over a data communications network 14 such as, for example, a public Internet. The users of the end user devices 12 are subscribed with the IE server 10 and belong to one or more MCs hosted by the IE server 10. For example, in the illustrated example, the end user devices 12a and 12b belong exclusively to MC1, end user device 12c belongs to both MC1 and MC2, and end user device 12d and 12e belong exclusively to MC2.

The IE server 10 is also coupled to one or more participating retailers via their retailer devices 16, and to one or more affiliates via their affiliate devices 18.

The IE server 10 includes one or more software modules for providing various inferred endorsement services to the participating end users, retailers, and affiliates. Such software modules may include a subscriber module 10a for interfacing with the end users via the end user devices 12, store module 10c for interfacing with the retailers via the retailer devices 16, and affiliate module 10b for interfacing with the affiliates via the affiliate devices 18.

The IE server 10 is also coupled to a mass storage device 19 such as, for example, a disk drive or drive array, for storing information used by the IE server 10 for providing the inferred endorsement services. For example, the mass storage device maintains information on each MC hosted by the IE server 10, including membership and product purchase information. The product purchase information may be maintained for each subscribed user, MC, and/or retailer. The mass storage device also stores profile and account information for each user, retailer, and affiliate.

According to one embodiment of the invention, the end user devices 12 and/or retailer and affiliate devices 16, 18 may connect to the data communications network using a telephone connection, satellite connection, cable connection, radio frequency communication, or any wired or wireless data communication mechanism known in the art. To this end, the devices may take the form of a personal computer (PC), hand-held personal computer (HPC), television and set-top-box combination, personal digital assistant (PDA), or6 any consumer electronics device known in the art.

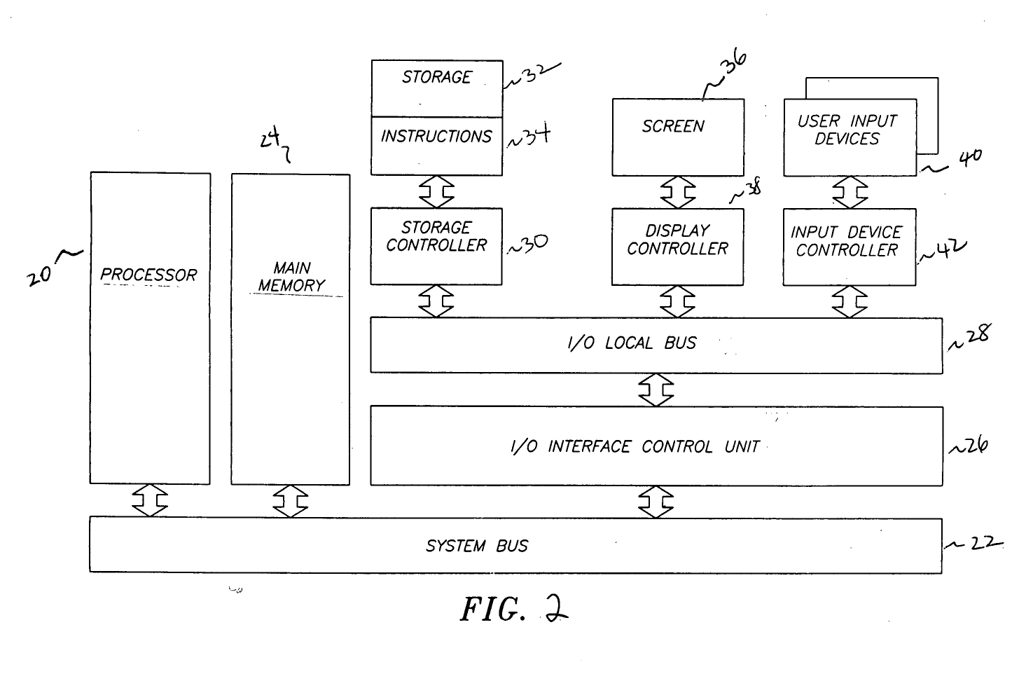

FIG. 2 is an architecture block diagram of the IE server 10, end user devices 12, and retailer and affiliate devices 16, 18 according to one embodiment of the invention. These devices each include one or more processors 20 operatively coupled via a system bus 22 to a main memory 24 and an input/output (I/O) interface control unit 26. The I/O interface control unit 26 is operatively coupled via an I/O local bus 28 to a storage controller 30. The processor 20 is coupled via the I/O interface control unit 26, the I/O local bus 28, and the storage controller 30, to a storage device 32. Computer program instructions 34 for implementing different functionalities of the IE server 10, end user devices 12, or retailer and affiliate devices 16, 18 are stored in the storage device 32 until the processor 20 retrieves the computer program instructions and stores them in the main memory 24. The processor 20 then executes the computer program instructions stored in the main memory 24 to implement a particular functionality. Such functionality may include web browsing functionality for displaying and interacting with web pages transmitted according to a web application protocol such as, for example, a Hypertext Transfer Protocol.

The IE server, end user devices 12, and retailer and affiliate devices 16, 18 may further include a screen 36 coupled to the I/O local bus 28 via a display controller 38. The screen is used to display images, text, video, and the like. The screen 36 may be coupled to the display controller 38 via a Universal Serial Bus (USB) communications link or by any wired or wireless video display connection known in the art.

The IE server 10 and the various devices 12, 16, 18 may also include one or more user input devices 40 coupled to the I/O local bus 28 via an input device controller 42. The user input devices 40 may include a keyboard, keypad, mouse, joystick, remote controller, microphone, and the like.

According to one embodiment, a user of an end user device 12 subscribes to the services provided by the IE server 10 via the subscriber module 10a. In this regard, the user accesses a registration web page provided by the subscriber module, and provides the user's registration information such as, for example, the user's name, e-mail address, credit card information, and the like. Upon receipt of the user registration information, the subscriber module automatically charges a subscription fee to the user's credit card. A notification may then be sent to the user of the user's successful subscription. According to another embodiment, the charging of the subscription fee is deferred until an expiration of a free promotional period. The user's registration information is then stored in the mass storage device 19 as part of the user's profile/account information.

A subscribed user may then invite friends, family, and others, to join the user's MC. In this regard, the user transmits to the subscriber module 10a, contact information of the people that the user wishes to invite to join the user's MC. The contact information may include, for example, an e-mail address, a telephone number, a physical address, or the like. The IE server uses the contact information to automatically generate invitations to the potential MC members. The invitation may take the form of an electronic mail, an instant message, an “evite”, or the like.

According to one embodiment of the invention, the invitation includes an URL link to the IE server 10. Selection of the URL link by an invitee causes the invitee's end user device to connect to the IE server 10 and display a registration page provided by the subscriber module 10a. The registration is then filled-out and submitted to the subscriber module 10a for joining the user's MC. The newly joined member may further generate his or her own MC, and invite a number of other people to join the new MC. However, the newly joined member may or may not be authorized to invite people to join the MC to which he or she was invited, depending on the degree of separation allowed by the MC creator. For example, if the maximum degree of separation between the MC creator and any invitee is two, the members of the MC may include the MC creator, people directly invited by the MC creator (referred to as direct members), and people invited by the direct members (referred to as indirect members). The indirect members, however, may not invite their family and friends to join the MC.

Once subscribed, the user may access the IE server 10 and view all posted transactions made by each member of the MC. The user may further search for particular transactions based on product descriptions, brand names, retailer information, member information, and the like. The user may also view or post on a bulletin board dedicated to the user's MC, reviews or comments on purchased products. Private messages may also be exchanged between members of the user's MC.

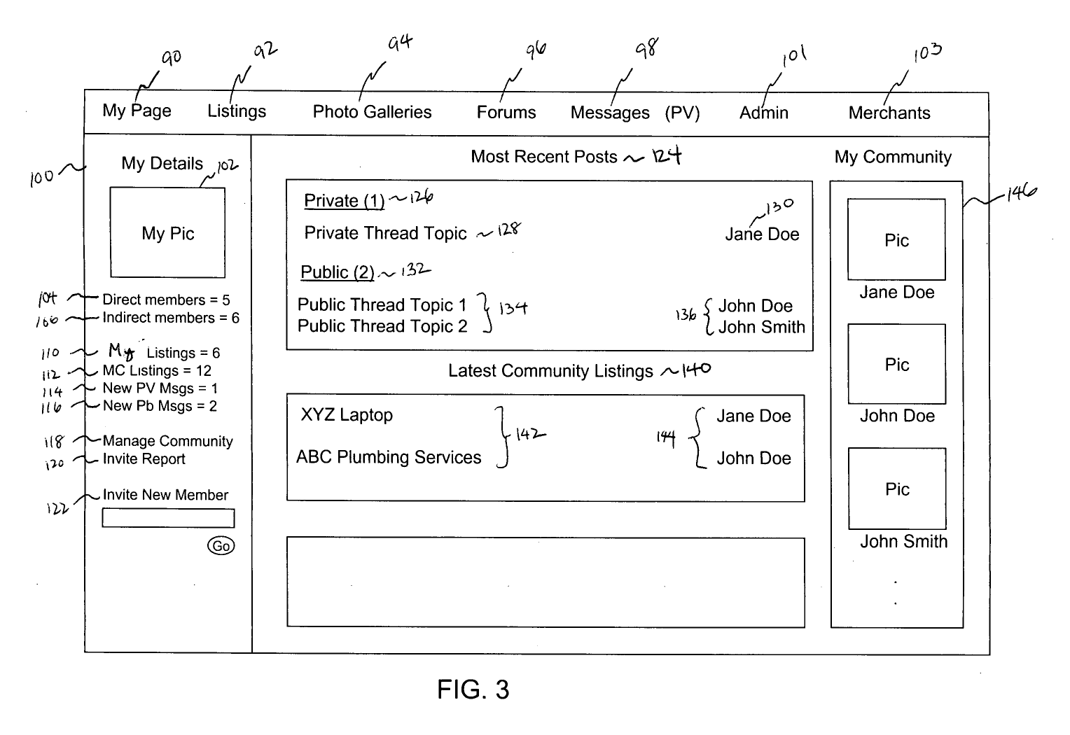

FIG. 3 is an illustration of an exemplary home page displayed to a user upon access to his MC according to one embodiment of the invention. The home page provides various navigation tabs for accessing different MC services and/or information. A “my page” tab 90 allows the user to return to his home page from other navigation pages. The user's home page is automatically displayed upon login by the user.

A “listings” tab 92 allows the user to view a private MC listings page displaying listings of products purchased by members of the user's MC, or a public listings page displaying listings of products purchased by members of other communities. The private MC listings page is viewable to only the members of the MC. The public listings page is viewable by all subscribed users from all communities. However, in the public listings page, the posting people may remain anonymous via usernames instead of real names. In the private listings page, although usernames are used, the MC members are provided with the real identity of people using the usernames.

Selection of a “photo galleries” tab 94 causes display of different photo galleries generated by the members of the MC, and further allows the user to share his own photo gallery with the members of his or her MC and/or other communities.

A “forums” tab 96 displays various types of bulletin boards accessible to the user, including, for example, a private forum, listings forum, and general forum. The private forum is a private bulletin board where members of the user's MC may post and view comments on different subjects. The listings forum is also a private bulletin board accessible to only the members of the user's MC, but is dedicated to discussions relating to products or services. The general forum is a public bulletin board accessible to any subscriber of the system even if the subscriber is a not a member of the user's MC. The public bulletin board allows members of different communities to engage in discussion about products or any other desired topic in an anonymous manner.

A “messages” tab 98 allows the user to access his or her private inbox that stores messages directed to the user by other MC members, and a public inbox that stores messages directed to the user by members of other communities. The separation of the private and public inboxes allow filtering of relevant messages from MC members, from possibly spam messages from members of other communities.

An “admin” tab 101 allows the user to manage the MC, edit and manage exposure of the user's personal profile information, and perform other administrative tasks.

A “merchants” tab 103 provides a merchant directory of the various merchants with whom members of the MC have had experiences, and provides information such as rating information about these merchants.

According to one embodiment of the invention, the user's home page is displayed upon login with the IE server 10. The home page includes a “My Details” portion 100 with information about the user, including the user's picture 102 and other profile and demographic information (not shown) about the user. A direct members link 104 identifies the direct members of the MC that have been invited by the user himself. An indirect members link 106 identifies the indirect members of the MC that have been invited to the MC by a direct member.

A my listings link 110 identifies the number of postings made to the private MC listings page by the user regarding products and services experienced by the user. An MC listings link 112 identifies the total number of postings made to the MC listings page regarding product experiences by all MC members.

A new private messages link 112 and new public messages link 114 identify the number of new messages in respectively the user's private and public inboxes.

A manage community link 118 allows the user to view and edit his or her MC. The user may further view a report of the people invited by the user via an invite report link 120. The user may conveniently invite friends and family to join the user's MC by entering the e-mail addresses of those people in an invite new member section 122.

A most recent posts section 124 of the user's home page provides a private forum link 126 identifying a number of recent postings 126 in one or more private bulletin boards accessible to the MC members, along with one or more thread topics 128 and information on one or more posting people 130. The most recent posts section also provides a public forum link 132 identifying a number of recent postings 132 in one or more public bulletin boards accessible to members of all communities, along with one or more thread topics 134 and information on one or more posting people 136. Selection of a listed private or public thread topic 128, 134, causes display of the posted message in the private or public bulletin board.

A latest community listings section 140 displays the latest product listings 142 posted on the MC listings page regarding products purchased by the MC members, and the particular MC members 144 posting the listings. Selection of a particular listing causes display of rating and other information relating to the purchase.

A my community section of the home page displays pictures 146 of the members of the user's MC. In this manner, the user may visually identify the people with whom comments and other information are shared.

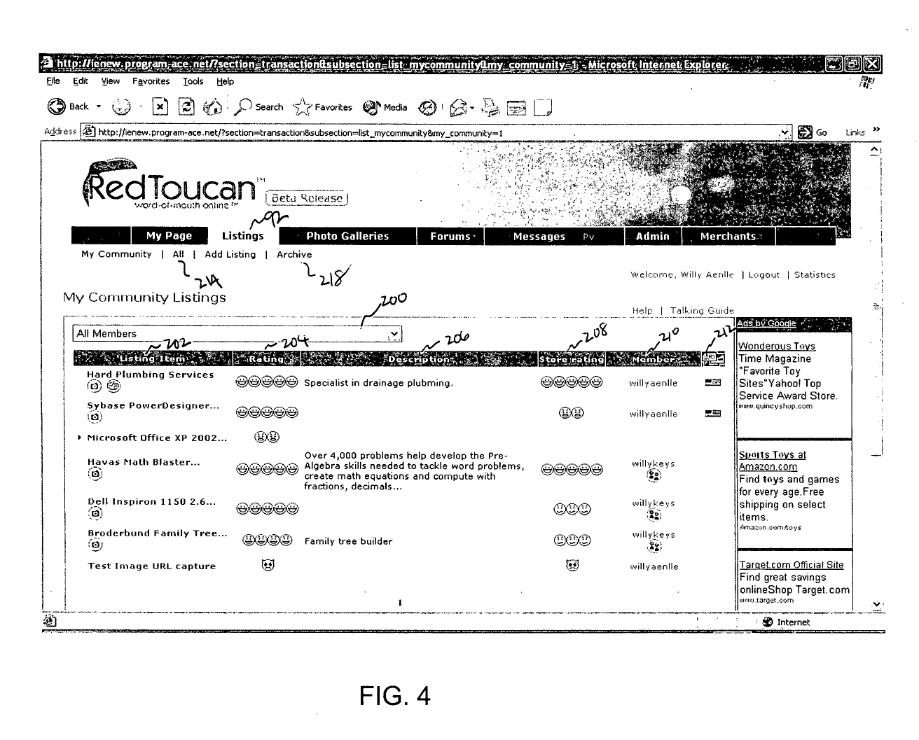

FIG. 4 is a screen shot of a private MC listings page displaying listings of products purchased and/or experienced by one or more members of the MC according to one embodiment of the invention. The illustrated page may be displayed, for example, upon selecting the listings tab 92 or the MC listings link 112. The user may view listings posted by all members of the MC, or filter the displayed listings based on individual members, including the user himself, by selecting the appropriate person in a selection window 200.

The items are listed by name 202 and associated with an item rating 204, item description 206, store rating 208, posting member identifier 210, and merchant country 212 information. The listed items may be sorted by name 202, item rating 204, store rating 208, and posting member identifier 210. The store rating 208 is the aggregate of all the ratings collected for the listed store or merchant. The member information 210 is the username for the posting member. Selection of the username causes display of the member's real identity and profile information, allowing the decloaking of members making the postings.

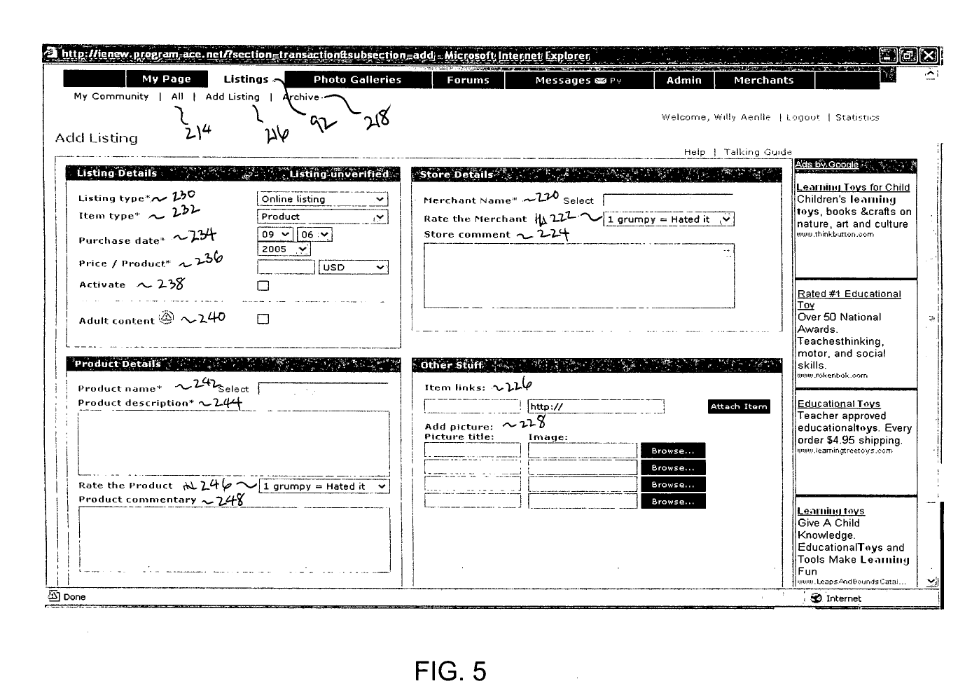

FIG. 5 is a screen shot of an add listings page for adding an entry to the MC listings page according to one embodiment of the invention. The add listings page may be displayed, for example, upon selection of an “add listings” sub-tab 216 under the listings tab 92.

A user desirous of adding an entry to the listings page provides listing details such as, for example, a listing type 230, item type 232, purchase date 234, and purchase price 236. The listing type 230 is selected to indicate the listing as being an online or offline listing. An offline listing is a listing for a product that is manually generated by a user. An online listing is a listing for a product that is automatically generated in response to the purchase of the product from a participating retailer. An online listing may be validated since the listing information is provided directly from the retailer, and thus, there is verification that the user indeed made the purchase. The item type 232 is selected to indicate whether the listing is for a product or service.

Setting an activate option 238 causes the listing details to be posted on the private MC listings page, the public listings page, or both, depending on whether a private listings setting has been set for the user's profile. For example, if the private listings setting has been set, the listing is only posted on the private MC listings page and thus, visible to only the members of the MC. If the private listings setting has not been set, the listing is posted on both the MC listings page and the public listings page. According to an alternative embodiment of the invention, whether a listing is private or public may be made on a listing-by-listing basis.

An adult content setting 240 indicates whether the listing is appropriate for only adults. In this regard, the IE server 10 may filter display of adult content listings based on the member's age. For example, listings with the adult content setting option set may not be displayed to members who are under 18 years of age.

In addition to the listing detail, the user further provides details on the product to be listed such as, for example, a product name 242 and description 244. The user then rates the product by selecting one of various rating levels 246. The user may explain the reasons for the rating and provide other commentaries in a product commentary area 248.

The user also provides a merchant name 220 from whom the product was purchased, and rates the merchant by selecting one of various rating levels 222. The user may also provide a commentary on the store in a store commentary area 224. Additional information that may be posted on the MC listings page include a URL link 226 to the merchant providing the product, and a picture 228 of the product.

In addition to the MC listings page, the IE server 10 provides a public listings page (not shown) upon selection of an “all” sub-tab 214 under the listings tab 92. The public listings page include listings of products purchased by members of other communities, and are publicly viewable to all subscribed members.

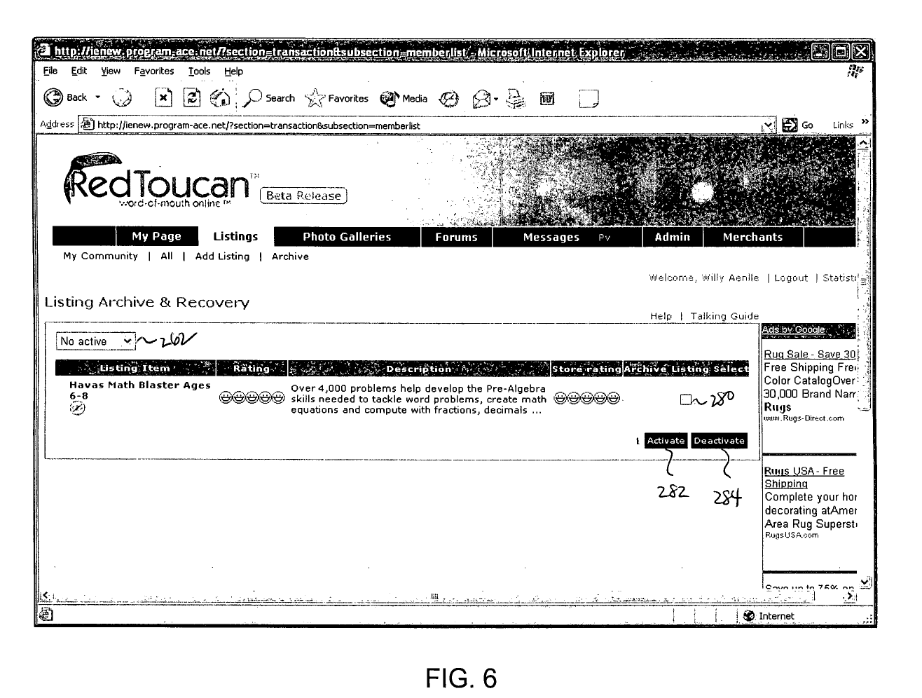

FIG. 6 is a screen shot of a purchase archive page according to one embodiment of the invention. The purchase archive page may be displayed, for example, upon selection of an archives sub-tab 218 under the listings tab 92. The purchase archive page displays the products purchased by the user as stored in a purchase listings database in the mass storage device 19. The user may view all listings, active listings, or inactive listings, by selecting a corresponding filter from a selection window 262. Active listings are listings that are exposed to the MC by causing it to appear on the private MC listings page, public listings page, or both. Inactive listings are listings that have not yet been exposed to either the MC or other communities. The user may modify the active/inactive status of one or more products by selecting these products via a selection option 280, and invoking an activate 282 or deactivate 284 button.

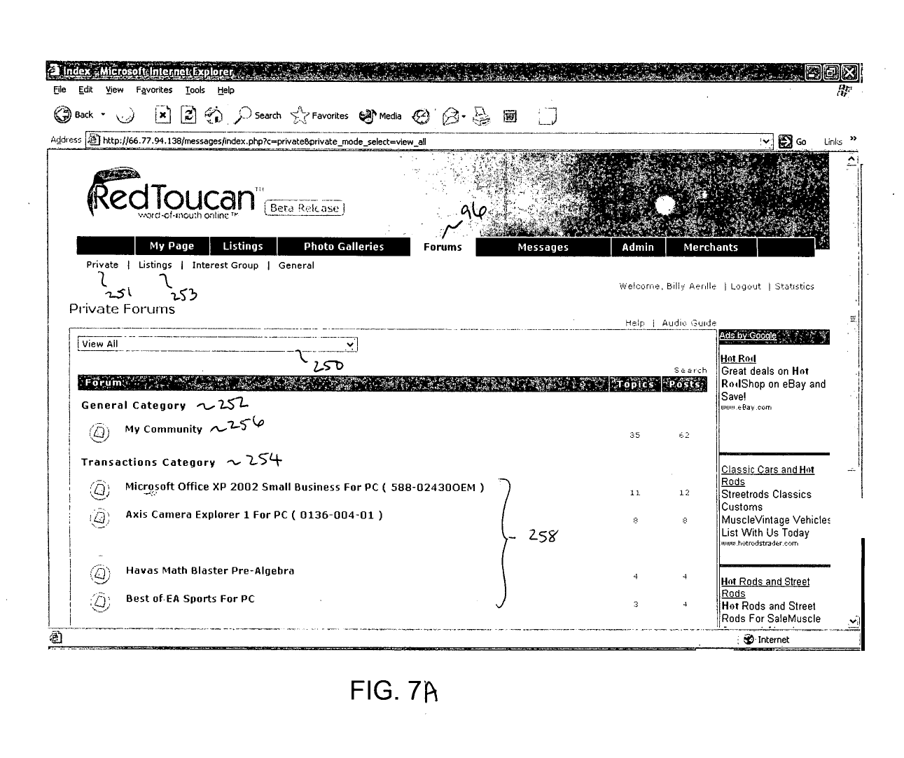

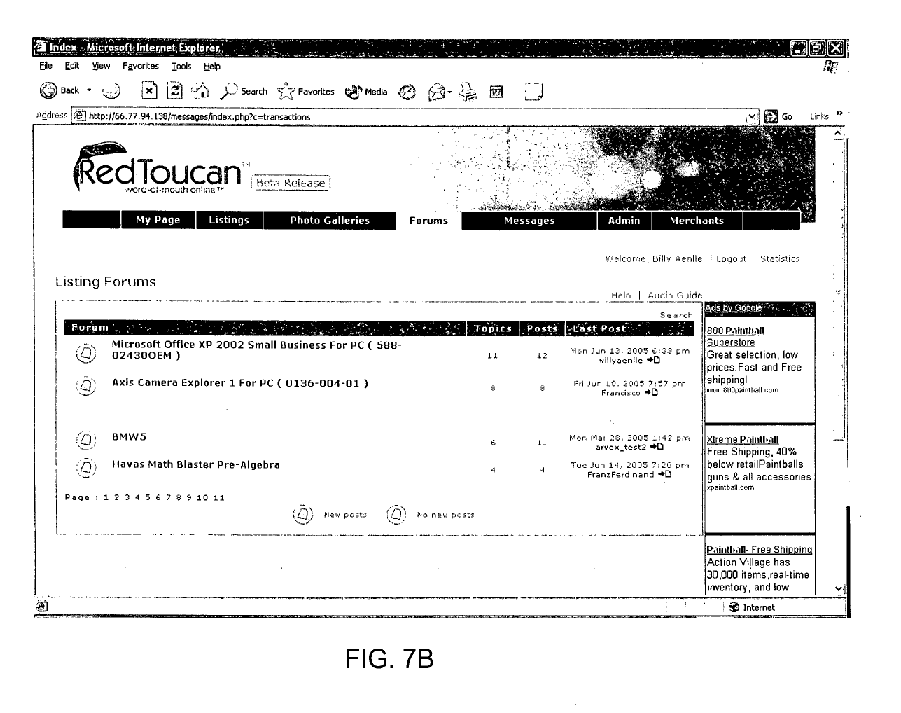

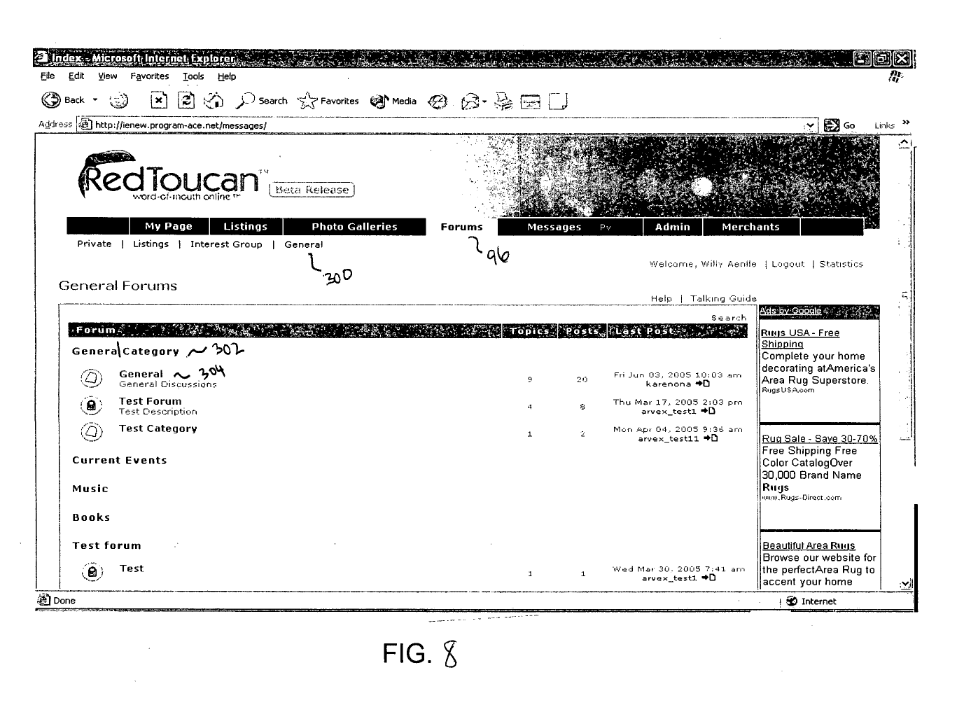

FIG. 7 is a screen shot of a page displaying various private forums according to one embodiment of the invention. The illustrated screen shot may be displayed, for example, upon selecting the forums tab 96 or a private sub-tab 251 under the forums tab. In the illustrated page, a general category section 252 lists one or more types of general forums accessible to the MC members. In the illustrated example, a My Community forum 256 is a private bulletin board where members of the MC may discuss any desired topic in an open and transparent manner.

A transaction category section 254 lists one or more products 258 for which a dedicated bulletin board has been generated for discussing the products. Selection of a particular product causes the display of the relevant bulletin board for allowing the user to view what other members, experiences have been with the product, and posting the user's own experience with the product.

Unlike other bulletin boards where the discussing members may remain anonymous, the discussing members in any of the private bulletin boards are people whose real identity is exposed to the MC, making the conversations more meaningful and interesting. A search field 250 provides various search options for searching and displaying posts matching the search. For example, the user may only want to search and view postings made by the user.

FIG. 7B is a screen shot of a public listings page according to one embodiment of the invention. The illustrated screen shot may be displayed, for example, upon selection of a listings sub-tab 253 under the forums tab 96. Unlike the listings in the transactions category section 254 of FIG. 7A, the listings on the public listings page reference public bulletin boards dedicated to discussions related to the particular listed product or service, which members from all communities may access.

Such public bulletin boards allow the user to search for user experiences on a particular product for which similar information is not available in the user's MC. In this scenario, the user may access the public listings page and search for discussions about the product. According to one embodiment, the IE server may provide a search option (not shown) for allowing the user to search the product databases maintained for the other MCs for the particular product. A successful match may identify the buyers of the particular product, people who had comments on the product, and/or whether a public bulletin board exists for the particular product. If no dedicated public bulletin boards exist for the particular product, the IE server may automatically generate one, and allow the user to post an inquiry for the particular product on the generated public bulletin board in an anonymous manner.

According to one embodiment of the invention, if a particular non-MC subscriber is identified as having information on the inquired product, the IE server notifies the subscriber of the inquiry placed on the particular product. If the notified subscriber provides an answer to the inquiry, the answer is posted on the public bulletin board.

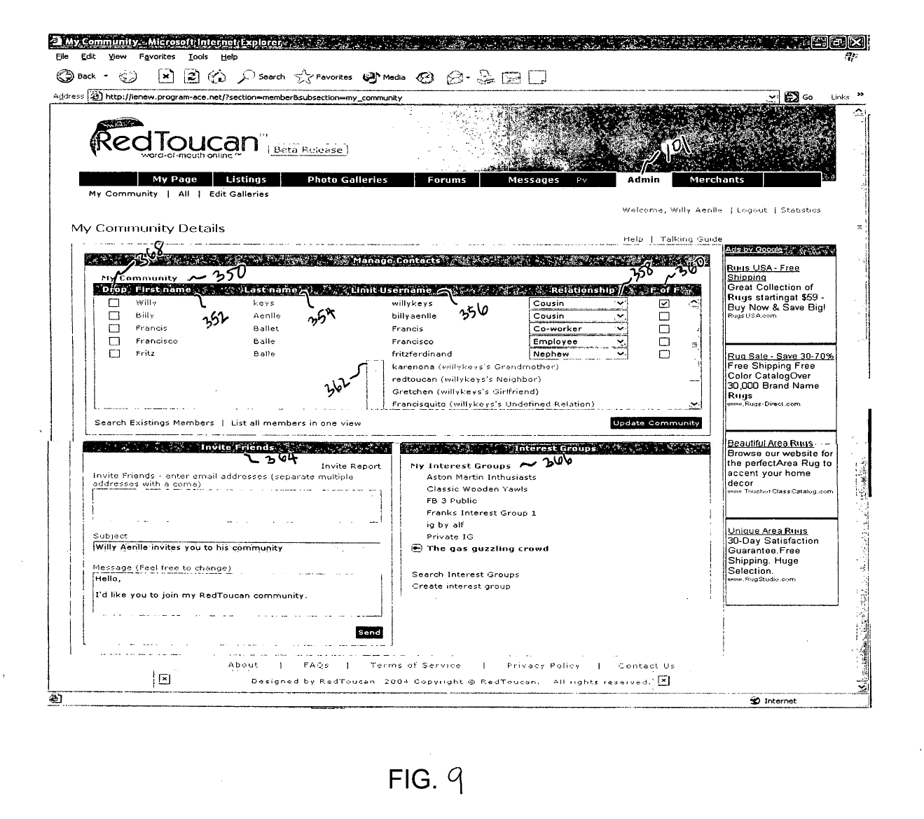

FIG. 8 is a screen shot of a page displaying various general forums according to one embodiment of the invention. The illustrated screen shot may be displayed, for example, upon selecting a “general” sub-tab 300 under the forums tab 96, or upon selection of the general forum link 132 on the user's home page. In the illustrated page, a general category section 302 lists one or more types of general forums available to all communities. In the illustrated example, a General forum 304 is a public bulletin board where members of the various communities may discuss different topics. Specialized categories may also be provided, such as, for example, current events, music, books, and the like, for generating public bulletin boards for the general categories.

FIG. 9 is a screen shot of a page displayed to the user for managing the user's MC according to one embodiment of the invention. The illustrated screen shot may be displayed, for example, upon selecting the “admin” tab 101, or upon selection of the “manage community” link 118 on the user's home page. In the illustrated page, a “my community” section 350 lists the direct members of the user's MC who have been invited to the MC directly by the user, based on their first names 352, last names 354, and usernames 356. The user may set the relationship of each direct MC member via a relationship selector 358. The user may exclude a member from his or her MC by setting a “drop” option 368 for that member.

According to one embodiment of the invention, a direct MC member may not in turn invite other members to join the MC unless authorized by the user. Such an authorization is given on a member by member basis by setting a friends-of-friends option 360. In this manner, the user controls how far removed the members of the MC are to the user.

Invitees of direct members (e.g. friends-of-friends) become indirect members of the MC, and are identified according to their usernames and relationship to the inviting direct member. The user may limit an indirect member's access to the MC by selecting a limit option 362. For example, the indirect members may be limited from accessing the user's profile, certain private forums, the user's photo gallery, and the like. In this manner, the user has ultimate control on how much information to expose to people other than immediate friends and family.

An “invite friends” section 364 allows the user to invite friends and family to join the user's MC. According to one embodiment of the invention, the invitation is transmitted as an evite that is delivered to the invitee's email address.

According to one embodiment of the invention, the user may also set different interest groups 366 and invite people to join the particular interest groups. The user may also control if a particular interest group is public or private.

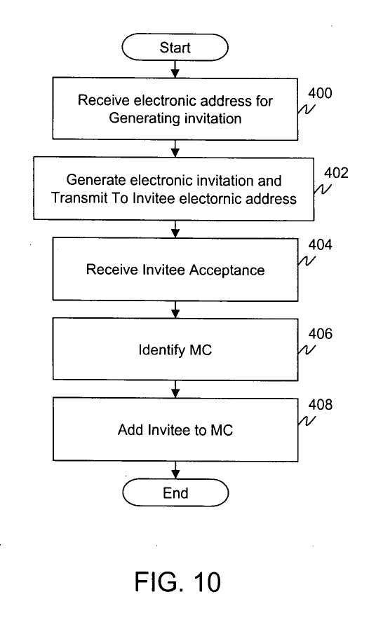

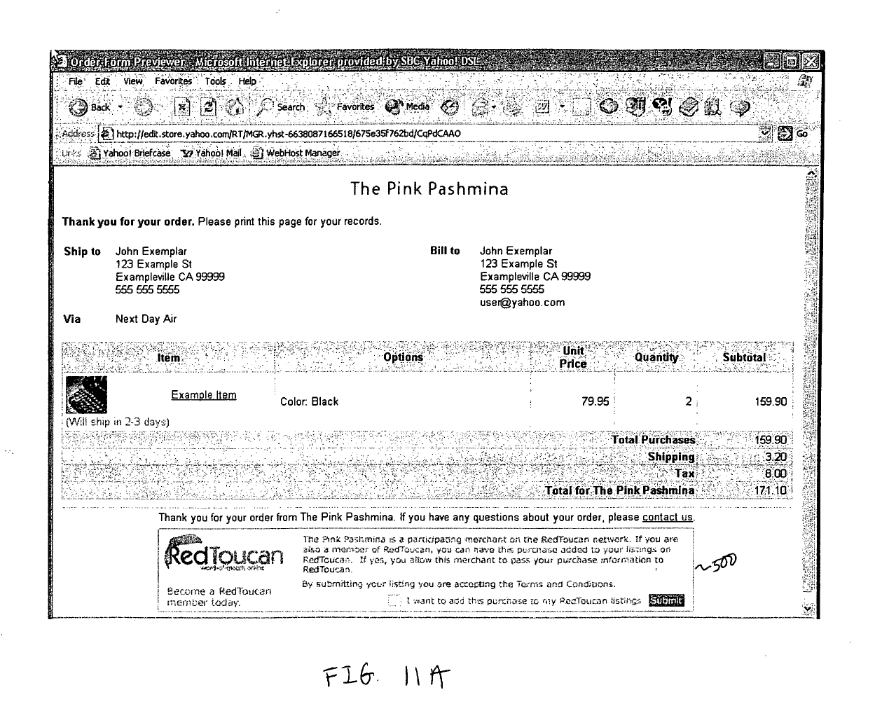

FIG. 10 is a flow diagram of a process implemented by the IE server's subscriber module 10a for populating an MC according to one embodiment of the invention. In step 400, the module receives an electronic address, such as, for example, an e-mail address, of a person to be invited to the MC. In step 402, the process generates an electronic invitation such as, for example, an evite, email message, instant message, and the like, and transmits the electronic invitation to the indicated address. According to one embodiment, such an electronic invitation is not generated if the person doing the inviting is restricted, by the creator of the MC, from inviting other invitees to join the MC. Such a determination may be made by the IE server by determining if the person doing the inviting has a friends-of-friends option set.

In step 404, the module receives an electronic acceptance indication to the invitation from the invitee. In generate the acceptance indication, the invitee accesses the module via, for example, a link provided in the invitation, and provides the invitee's registration information. According to one embodiment, the module is configured to maintain track of outstanding invitations for the user, and as acceptances are received, correlate the acceptances with the invitations. Any of various well known mechanisms may be utilized to allow such correlation of acceptances with invitations and relevant MCs.

In step 406, the module identifies the MC to which the invitee is to be added, and proceeds to add the invitee to the MC in step 408.

According to one embodiment of the invention, a retailer may also subscribe to the inferred endorsement service provided by the IE server via a store module 10c. In this regard, the retailer accesses a registration web page provided by the store module, and provides the retailer's registration information such as, for example, the retailer name, website, types of products and services offered by the retailer, contact information, credit card information, and the like. The retailer's registration information is then stored in the mass storage device 19 as part of the retailer's profile/account information.

A participating retailer provides via its retailer device 16, a website that allows on-line purchases of products offered on the website. According to one embodiment of the invention, a subscribed retailer provides on its website a mechanism for MC members to submit a query for products purchased from the retailer by other MC members. In this regard, the retailer server first determines whether the user accessing the retailer website is a current subscriber of the inferred endorsement service. This may be accomplished, for example, by transmitting the user's identification information to the IE server for a match. The user's identification information may be, for example, the user's e-mail address. A query for a particular product or products submitted by a subscribing user is forwarded to the IE server for generating a response.

According to one embodiment of the invention, a subscribed retailer further provides on its website a mechanism that allows the automatic posting of an MC member's product purchases from the retailer, to the user's MC. Because the purchase of a product in-of-it itself acts as an endorsement of the product by the purchaser, the retailer has great incentive to make such product purchases known to others.

According to one embodiment of the invention, the retailer's website includes a shopping cart module that includes next to each item stored in the user's shopping cart, an “endorsement check box.” The user may select the box for each item that the user wishes to disclose to the other MC members.

Upon the completion of a current purchase transaction, all items with a checked endorsement check box are posted to the purchasing user's MC. In this regard, the purchasing user's archive page (FIG. 6) is updated with the endorsed products. The endorsed products may then be posted on the MC listings page, public listings page, or both. Individual notifications may also be sent to the MC members via e-mail, instant messaging, and/or the like, upon posting on the MC listings page.

According to one embodiment of the invention, an inferred endorsement of a product by a purchasing MC member by posting the purchase information to the MC causes the IE server to automatically calculate a commission amount for the endorsement, and debit the retailer's account for the calculated amount. A notification may then be transmitted to the retailer of the endorsement and account debit.

In another embodiment of the invention, an MC member's purchase information from a retailer may be submitted to the IE server even if the retailer is not yet registered with the IE server 10. In this regard, the MC member may provide to the retailer the IE server's e-mail address for sending a purchase confirmation to the IE server's e-mail address. The IE server receives the purchase confirmation and updates the MC member's archive page based on the purchase confirmation information. The IE server may then automatically prompt the retailer to subscribe to the IE server if the purchase information is to be activated and made viewable by other MC members. Alternatively, the purchase information may be activated without requesting registration by the retailer.

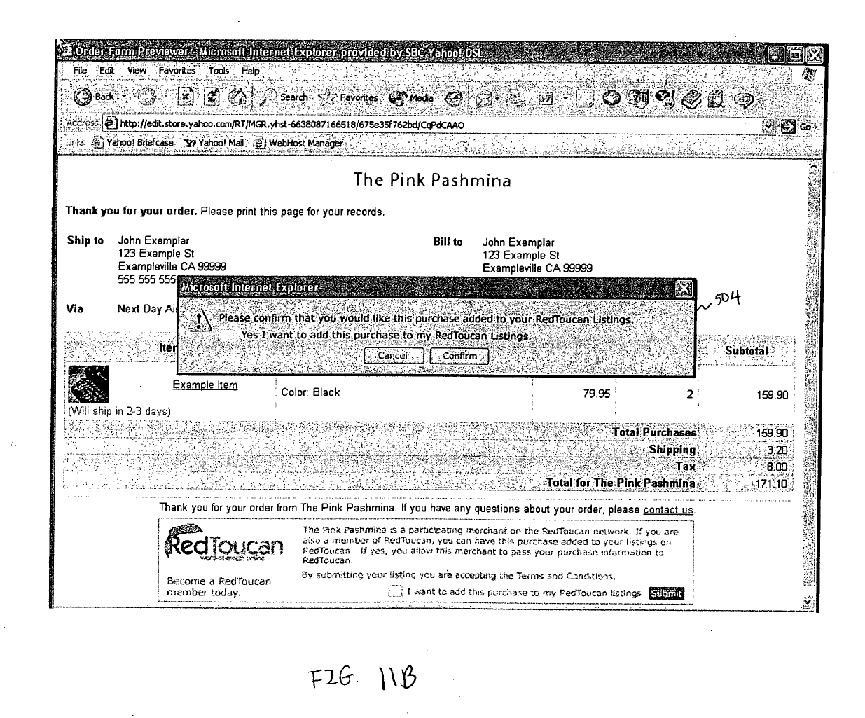

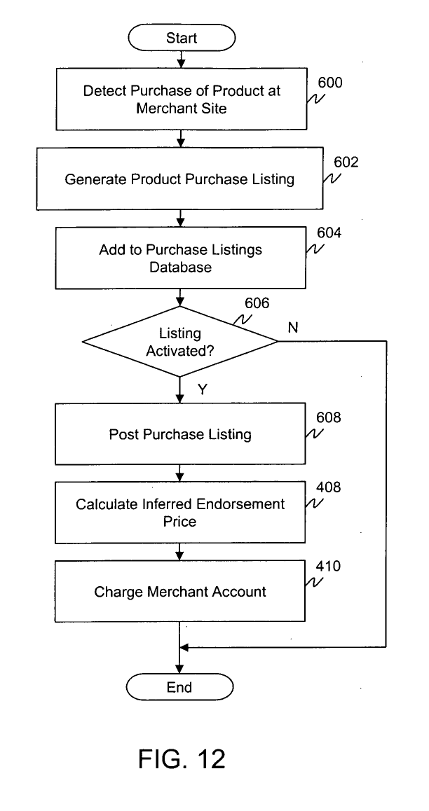

FIGS. 11A-11B are screen shots of pages displayed to the user by the retailer device 16 upon completion of a purchase from the retailer according to one embodiment of the invention. A message 500 displayed upon completion of the purchase indicates that the retailer is a participating merchant, and inquires whether the purchase should be added to the user's purchase listings. If the user selects a “submit” button 502, the retailer device 16 causes display of a confirmation message 504 asking the user to confirm the addition of the purchase information to the user's purchase listings. Upon confirmation, the purchase information is transmitted to the IE server 10. In this regard, the retailer device 16 bundles the purchase information with information on the merchant from whom the purchase was made, and transmits the bundled information to the IE server's store module 10c.

The store module 10c receives the purchase and merchant information, and automatically generates a product listing based on the received information. The automatically generated product listing may include information similar to the information provided in the add listings page of FIG. 5. For example, the automatically generated product listing may include the listing type 230, item type 232, purchase date 234, purchase price 236, product name 242, product description 244, merchant name 220, item link 226, and item picture 228.

According to one embodiment of the invention, the automatically generated product listing is posted on the user's archive page. In order to expose the newly generated listing on the MC listings page and/or public listings page, the user accesses his or her archive and sets the activate option for the product listing. Alternatively, the listing may be automatically posted on the MC listings page and/or public listings page even without the manual activation.

If the posting user desires to edit the listing or add further information for the listing, he or she may do so by invoking an edit page. The edit page may be invoked, for example, by double clicking on the listing on the MC listings page, public listings page, and/or archive. The edit page may be similar to the add listings page of FIG. 5. Via the edit page, the user may add information such as, for example, product or store rating, product or store comments, and the like.

The store module 10c is configured to maintain track for all listings activated and made viewable for a particular merchant, and automatically bill the merchant for such activated listings. The merchant may electronically make payments for the billed amount. Alternatively, the price for the activated listings may be automatically deducted from an electronic account maintained for the merchant.

FIG. 12 is a flow chart of an inferred endorsement process according to one embodiment of the invention. In step 600, the store module 10c detects purchase of a product at a merchant site. This may occur, for example, upon receipt of a purchase confirmation receipt that is forwarded directly by the merchant to the store module 10c upon purchase of the product by an MC member.

In step 602, the store module generates a product purchase listing based on the information transmitted in the purchase confirmation receipt. According to one embodiment of the invention, the information in the purchase confirmation receipt is tagged with computer-readable tags so as to allow the store module to automatically identify and retrieve the relevant information for automatically generating the purchase listing.

In step 604, the product purchase information is added to the purchase listings database and/or the purchasing member's archive page.

According to one embodiment of the invention, the purchase information is not exposed to the MC or to other communities absent activation of the listing from the user. Thus, in step 606, a determination is made as to whether the listing has been activated. If the answer is YES, the store module, in step 608, posts the purchase listing in the private MC listings page, public listings page, or both.

In step 610, the store module proceeds to calculate an inferred endorsement price to the charged to the merchant that is being promoted via the posting.

In step 612, the store module charges the merchant's account with the calculated amount.

According to one embodiment of the invention, any revenues calculated by the IE server from subscription fees, commission fees, and/or the like, are shared with affiliate partners who promote the IE service on their websites and draw new subscribers to the IE server. Affiliate partners may include web portals such as, for example, Yahoo!, MSN, and AOL. These web portals may, upon their own subscription with the IE server via the affiliate module 10b, provide a link to the IE server and allow users of such portals subscribe to the IE service. For each subscribed MC user, therefore, information may be maintained of the affiliate, if any, that facilitated the subscription of the user. Payments may then be automatically calculated for the affiliate, and credit the affiliate's account based on generated revenues.

Although this invention has been described in certain specific embodiments, those skilled in the art will have no difficulty devising variations to the described embodiment which in no way depart from the scope and spirit of the present invention. For example, it should be apparent that in addition to product and service purchase information, the inferred endorsements may be of other items that a person may experience and may want to rate, such as movies, restaurants, vacation spots, and the like. The MC may also be used to allow members of the MC to stay connected by sharing pictures, events, and the like.

Furthermore, to those skilled in the various arts, the invention itself herein will suggest solutions to other tasks and adaptations for other applications. It is the Applicant's intention to cover all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive.

1. A method for generating an online community, the method comprising:
generating an electronic invitation for an invitee to join a particular online community;
transmitting the electronic invitation to the invitee;
receiving an electronic acceptance indication to the invitation;
adding the invitee to the particular online community;
providing a website for the particular online community; and
exchanging product and service experience information among the online community members via the website.

2. The method of claim 1 further comprising:
automatically posting on the website information on purchases made by the online community members.

3. The method of claim 2 further comprising:
generating a dedicated electronic bulletin board for a particular purchased product or service.

4. The method of claim 2, wherein the information is a product or service rating information.

5. The method of claim 1, wherein the invitee is restricted from further inviting a second invitee to the online community.

6. An inferred endorsement method comprising:
detecting purchase of an item at a merchant site;
posting information about the purchased item at a second site;
limiting access to the second site to members of a micro-community; and
electronically charging the merchant in response to the posting of the information.

7. The method of claim 6 further comprising:
generating a dedicated electronic bulletin board for the purchased item on the second site.

8. The method of claim 6, wherein the information is an item rating information.

9. A system for generating an online community, the system comprising:
a first end user device generating a request to invite an invitee to join a particular online community;
a server coupled to the first end user device, the server receiving the request and in response, transmitting the electronic invitation to the invitee;
a second end user device coupled to the server, the second end user device receiving the electronic invitation and generating an electronic acceptance indication in response,
wherein the server adds the invitee to the particular online community and provides a website for the particular online community for allowing exchange of product and service experience information among the online community members.

10. The system of claim 9, wherein the server automatically posts on the website information on purchases made by the online community members.

11. The system of claim 10, wherein the server provides a dedicated electronic bulletin board for a particular purchased product or service.

12. The system of claim 10, wherein the information is a product or service rating information.

13. The system of claim 9, wherein the invitee is restricted from further inviting a second invitee to the online community.

14. An inferred endorsement server comprising:
a processor; and
a memory operably coupled to the processor and having program instructions stored therein, the processor being operable to execute the program instructions, the program instructions including:
detecting purchase of an item at a merchant site;
posting information about the purchased item at a second site;
limiting access to the second site to members of a micro-community; and
electronically charging the merchant in response to the posting of the information.

15. The server of claim 14, wherein the instructions further comprise:
generating a dedicated electronic bulletin board for the purchased item on the second site.

16. The server of claim 14, wherein the information is an item rating information.
